(19) United States
(12) Patent Application Publication
(10) Pub. No.: US 2008/0155103 A1
(43) Pub. Date: Jun. 26, 2008

(54) AF UNIX Socket Across Systems in the Same Computer on Computer Systems that Support Multiple Operating System Images

(76) Inventor: Kimberly Tekavec Bailey, Raleigh, NC (US)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/614,228

(22) Filed: Dec. 21, 2006

(51) Int. Cl. G06F 15/16

(52) U.S. Cl. 709/227

(57) ABSTRACT

The present invention is directed to a system, method and software program product for extending the use of Unix domain sockets to support multiple operating system images. An application creates a Unix domain socket using the sockets system call and binds the socket to a system file pathname for a service using an appropriate system call. The system file pathname represents the connection binding to the service. The operating system running the application may recognize that the service does not reside on the same operating system image and, therefore, a Unix domain socket cannot be used to communicate. To the operating system the system file pathname represents the binding that translates to a pathname that represents a real I/O device for cross-system communications. The operating system translates the system file pathname to a device pathname for the service. An appropriate transport is selected for the device and the transport invokes the point-to-point I/O device. Interprocess communication can then proceed.

### BACKGROUND OF THE INVENTION

The present invention relates to interprocess communication sockets.

Sockets provide for two-way communication between computer programs (applications) running on the same computer system or on different computer systems. Sockets are system calls (or services) provided by a computer operating system (or kernel) that define the interface for this communication, Applications typically interface to socket system calls using high-level application programming interfaces (API's) that allow them to easily invoke these calls to communicate with a partner application.

Each application begins this communication with the socket( ) API call which returns a descriptor (or handle) representing their endpoint of the communication. This descriptor is then used to make subsequent socket calls, such as bind( ), connect( ), read( ) and write( ), that act upon each endpoint to create a logical communication channel (or pipe) and allow for the sending and receiving of messages between these applications. With sockets, each endpoint has a way to identify itself uniquely.

Sockets have attributes that allow applications to determine how they communicate, these ares domain (or address family), protocol and type. The domain defines where applications will reside in the communication area, and how they will uniquely identify themselves in this communication. Two of the most popular communication domains are:
Unix Domain (AF_UNIX)—for communication between applications that reside on a single operating system.
Internet Domain (AF_INET)—for communication between processes on the same or different operating systems using the DARPA standard protocols (IP/UDP/TCP). Typically this is used for network communication.

The specified protocol defines how the data will be sent across the communication pipe. Applications cannot communicate across domains. For example, applications in the Unix domain cannot communicate with applications in the Internet domain.

When applications issue the socket( ) call, they specify the domain of communication, for example s=socket(AF_Unix,STREAMS) where s is the returned socket descriptor that defines the communication endpoint. The socket descriptor is used on subsequent socket system calls such as bind(s,) connect(s). read(s,), and write(s,) to communicate on that endpoint. The bind( ) and connect( ) socket calls allow the application to identify themselves by specifying their unique address, and they also establish the logical communication channel. This creates the binding for communication. In the Unix domain, the address and binding for each endpoint is a filename (this can include the file pathname). This represents a real file name in the Unix file system. An example of this would be “/var/sock/service”. In the Internet domain, the address is an IP address (sometime called an internet address) and port, where each application endpoint has a unique address. An example of this would be IP address 9.25.100.2 and port 25. This is used for communication using the well-known TCP/IP protocol. After the applications have opened their sockets and selected their addresses, they will typically perform a role in the popular client/server mode, where a server application would perform the bind(s,“/var/sock/service”) and the client would perform the connect(s,“/var/sock/service”) socket calls, establishing the logical connection. Once the communication binding occurs, the applications use the socket to send and receive messages, and the underlying system carries out this work.

At the operating system level, sockets are typically implemented using a layered approach. The socket system calls define the system interface, and are first processed by the operating system's logical file system (LFS). This is appropriate since the socket is an endpoint for performing input/output (I/O). On some computer systems, once the logical file system has determined that the endpoint is a socket, it will then pass this to the physical file system (PFS) that is associated with the socket's domain (address family). From the PFS, the system calls the transport layer which implements the communication protocol, packaging the messages to be sent and in some cases providing flow controls.

In sockets, the messaging that occurs for the domain and protocol (binding/connecting), and the messages sent and received by the applications must be carried out by the underlying operating system. In the case of Internet domain, where applications on different systems use sockets to communicate, the messages are sent by the transport layer to be processed by additional Tcp/Ip protocol layers, and are then sent to a network hardware interface to send the message out of the system. In the case of the AF_Unix socket domain, where communication occurs between applications on the same system that have bound to the same system filename, from the transport layer, messages are copied by the operating system between the processes (i.e. copied from one application memory space to another).

It is easy to see that a socket is not a physical component, but is completely a software object. Sockets simplify program development because the programmer need only worry about manipulating the socket descriptor, and can rely on the underlying operating system to handle the protocol exchanges and deliver the message.

### BRIEF SUMMARY THE INVENTION

The present invention is directed to a system, method, and software product for extending the use of Unix domain sockets to support communication across operating system images. A Unix domain system call is received from a process running on a first operating system, the system call is to establish communication with a second process. A file system pathname is recognized in the system call and translated into a real I/O device pathname. A connection to the second process is established using the device pathname.

### BRIEF DESCRIPTION OF THE SEVERAL VIEWS OF THE DRAWINGS

The novel features believed characteristic of the present invention are set forth in the appended claims The invention itself, however, as well as a preferred mode of use, further objectives and advantages thereof, will be best understood by reference to the following detailed description of an illustrative embodiment when read in conjunction with the accompanying drawings wherein:

FIG. 1 is a diagram representing a typical Unix domain client and server application model represented in prior art.

FIG. 2 is a diagram representing a typical Internet domain client and server application model represented in prior art;

FIG. 3 is a diagram representing the logical relationship between the system layers for a Unix client/server model known in the prior art;

FIG. 4 is a diagram representing the logical relationship between the system layers for a Unix client/server model as modified in accordance with an exemplary embodiment of the present invention;

FIG. 5 is a table of file system pathname definitions with the corresponding representative device pathnames in accordance with an exemplary embodiment of the present invention; and

FIG. 6 is a flowchart depicting the operating system determining if the Unix Domain file name used as the communication endpoint address represents cross-system or cross-memory communication.

Other features of the present invention will be apparent from the accompanying drawings and from the the following detailed description.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the users computer, partly on the users computer, as a stand-alone software package, partly on the users computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

An application that uses sockets for communication must understand its role as a server (service provider) or client (consumer), and determine the socket domain that it will communicate in. Only applications that open sockets in the same domain can communicate. Applications in the Unix sockets domain require that both client and server reside on the same operating system. For existing Unix domain applications to communicate with partners on another operating system, these applications could have their programs modified to use the Internet socket domain.

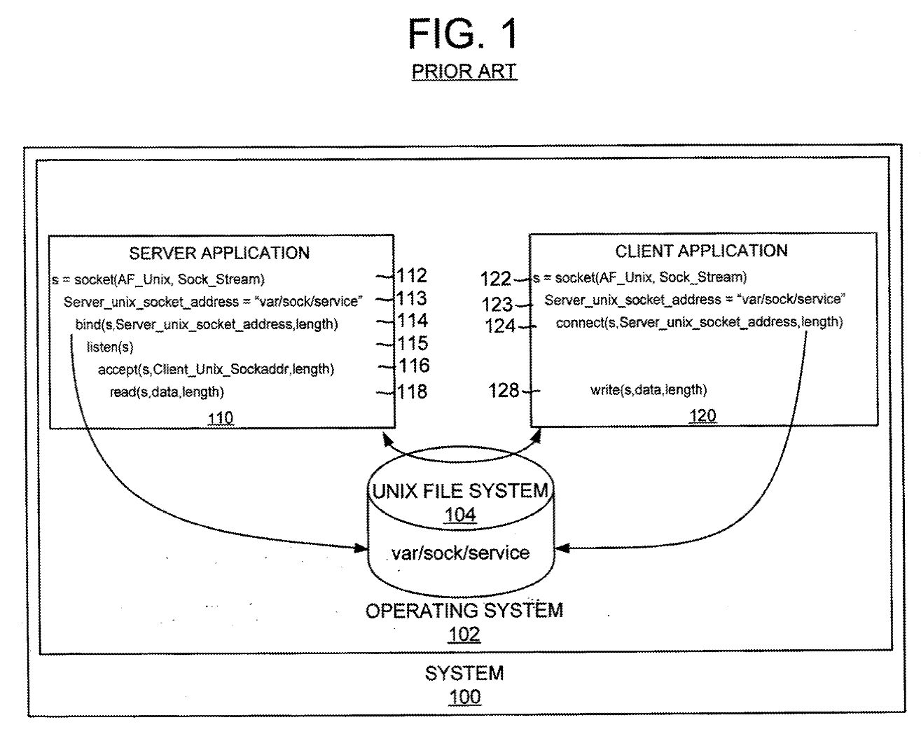

The methodology for Unix domain socket communication at the application layer established in prior art is represented by the diagram illustrated in FIG. 1. With regard to FIG. 1, client application 120 and server application 110 are each running on operating system 102 on system 100. The client-server model depicts a client that intends to establish a connection to a server which supports a particular service. More particularly, client application 120 intends to establish a connection to server application 110. Both the client and server operations are initiated with the “socket( )” system call which creates the socket and returns the socket descriptor handle (steps 122 and 112, respectively). The server then uses the socket to bind( ) to a service(step 114), for example “/var/sock/service” 113, and listen( )'s for client applications to connect( ) to the same service (step 115). The server will then accept( ) connections from clients (step 116). It is the bind( ) and connect( ) socket calls that establish the binding to the service and the start the logical communication channel which is completed by the accept. The service is a filename in the operating system's file system. From here, the client and server use read( ) and write( ) (steps 128 and 118) system calls to send and receive messages over the logical communication channel.

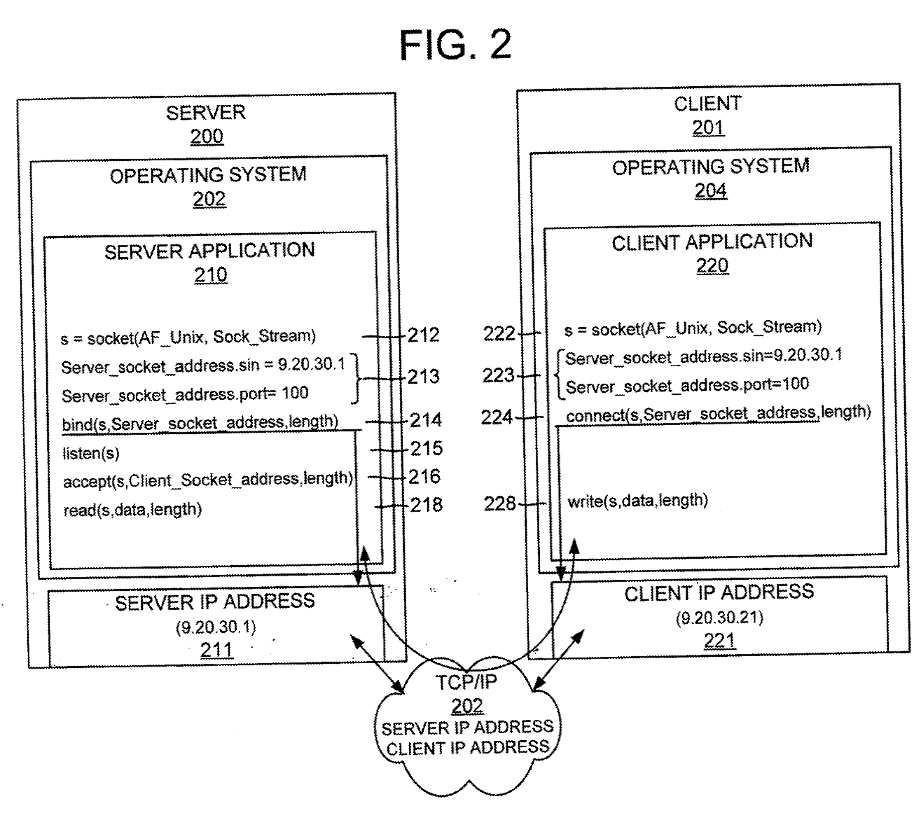

FIG. 2 depicts a situation where two applications on different computer operating systems communicate using sockets across the Internet domain as is understood in the prior art. This examines the application layer. Here, unlike the case described above with regard to FIG. 1 client 201 is separate from server 200 running its own operating system 203 and client applications 220. Summarily, server 200 supports a unique operating system 202, upon which server application 210 is running. Both the client and server operations are initiated with the “socket( )” system call which creates the socket and returns the socket descriptor handle. (steps 222 and 212) The server then uses the socket to bind( ) to a local internet address and port, which represents the service that is being provided (step 214), and listens (step 216) for client application 220 to connect( ) to the service (step 224). The connect( ) causes an implicit binding to a local IP address and port. The server will then accept( ) connections from clients (step 216) and in doing so learns the client's internet address (IP address and port). At this point, the communication binding is established and the logical communication channel is open. This unique communication channel is represented by the server's internet address and the client's internet address. From here, the client and server use read( ) and write( ) (steps 228 and 218) to send and receive messages over the logical communication channel.

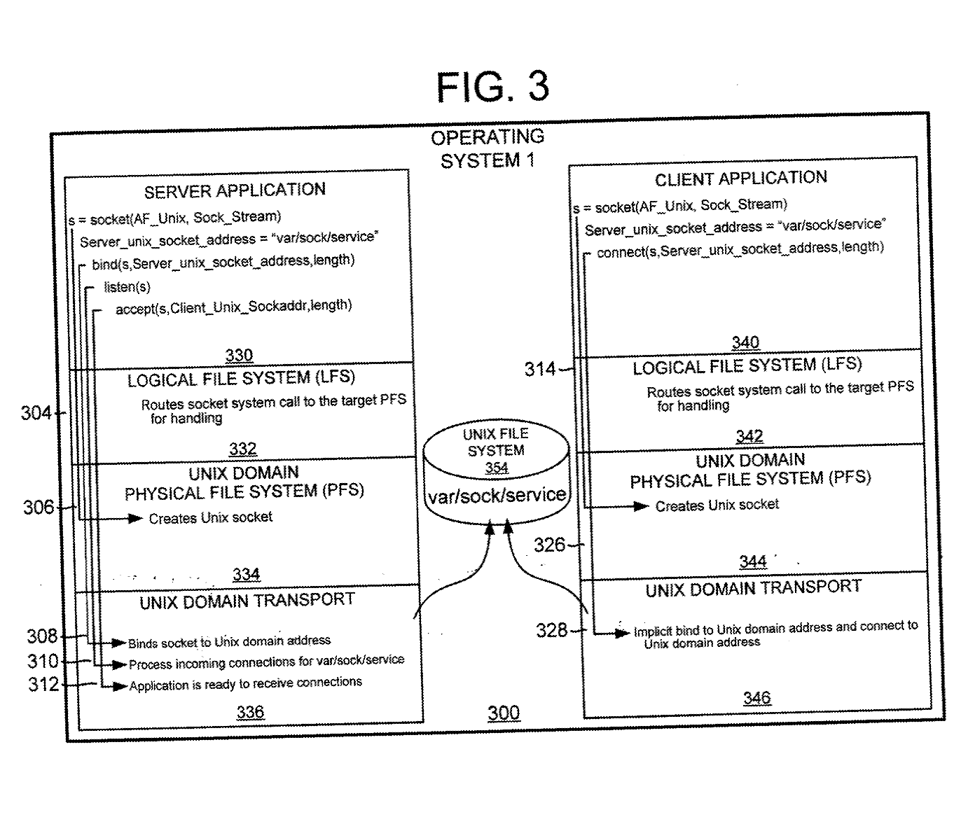

FIG. 3 is a diagram depicting a Unix domain client and server application using a streams transport as in prior art and how the socket calls are processed by the layers of the operating system. When the socket( ) system call is issued by either client application 340 or server application 340, the logical file system (LFS) layers 342 and 332 process the call and routes it to physical file system (PFS) layer 344 and 334 that understands the addressing for the Unix sockets domain and indicates a streams transport (steps 314 and 304). A representation of the socket endpoint is created and returned to the application which is then used for subsequent socket calls (steps 326 and 306). On the server side, the bind( ) system call and on the client side the connect( ) system call both specify the Unix domain address, which is a file system name (var/sock/service). LFS 332 passes the bind( ) and connect( ) calls to PFS 334 where the socket endpoint is associated with the Unix domain address (file system name) and the operating system unique identifier that represents the application (steps 328 and 308). This represents the binding for communication between the client and server. The binding to the service for each application is complete. In the case of server application 330, the listen( ) and accept( ) system calls are passed to and processed by transport layer 336 as is the connect( ) on the server side. The listen( ) tells transport layer to process incoming connections from the clients (step 310). Accept( ) indicates to transport layer 336 that the server application is ready to receive the connections from the client located on the same operating system image that are connecting to the /var/sock/service (step 312). On the client side, PES 344 passes the connect( ) request to transport layer 346 for Unix domain streams sockets which builds the messages to send to the server using a cross memory copy. The Unix domain socket's transport processes the incoming connection request and sends it up to listener application completing the accept( ). The listener side's transport sends a response to the client and transport layer 346 indicates a completed connection. This now represents a logical channel for communication between the client and server applications using the Unix file system 354. They can use their sockets to send and receive messages which are processed by the transports and sent up to the applications.

Applications that are using Unix sockets, but wish to communicate with applications on a different operating systems using sockets would require changes to their application programming logic. One way to do this would be to change them to use the Internet socket domain described in FIG. 2. In doing this, the data communicated across the network pipe is exposed to the network and may be exposed to the Internet. This requires consideration for how to protect potentially sensitive data. There is also the cost of rewriting the applications.

Some computer systems are tightly coupled. For example, some computer systems support logical partitioning such that a single physical system supports multiple operating system images. On these systems, special hardware instructions have been developed to allow for communication between these systems for Input/Output. Also, even separate computer systems may be physically linked for communication using a point to point (such as channel to channel) input/output device which provides for a tight coupling. It is on these types of systems that the present invention, the modfication of the operating system to support Unix domain sockets between applications that reside on different operating systems would provide benefits.

Accordingly, and according to one exemplary embodiment of the present invention, the use of Unix domain sockets are extended to support communication across operating system images. Hereinafter, this concept is referred to as “cross-system Unix domain sockets.” Cross-system Unix domain sockets are especially applicable to operating systems that communicate using a point to point hardware input/output (I/O) communication interface (device). On such systems, applications that use Unix domain sockets for communication currently specify a filename, which represents a real name in the file system, when binding or connecting to the partner application. In extending the Unix domain sockets for cross system communication, this filename will be extended to represent a real communication hardware interface path, filename, and target application. This may be accomplished, for example, by the operating system layers that participate in performing Unix domain sockets, in that they will provide a transformation (mapping) of the Unix domain filename to the extended filename to allow communication with a target application. Operating systems that support cross-system Unix domain sockets will require changes to the layers that support Unix domain sockets. This will be transparent to the applications using cross-system Unix domain sockets, and does not require programming changes to these applications since they will continue to bind( ) and connect( ) to their usual Unix filename. Thus, in accordance with one exemplary embodiment of the present invention, it is unnecessary to change the applications to use the Internet socket domain. Furthermore, the use of the present invention enables applications running on separate operating system images, but on the same system, to establish a connection within the system, thereby eliminating exposure to the Internet.

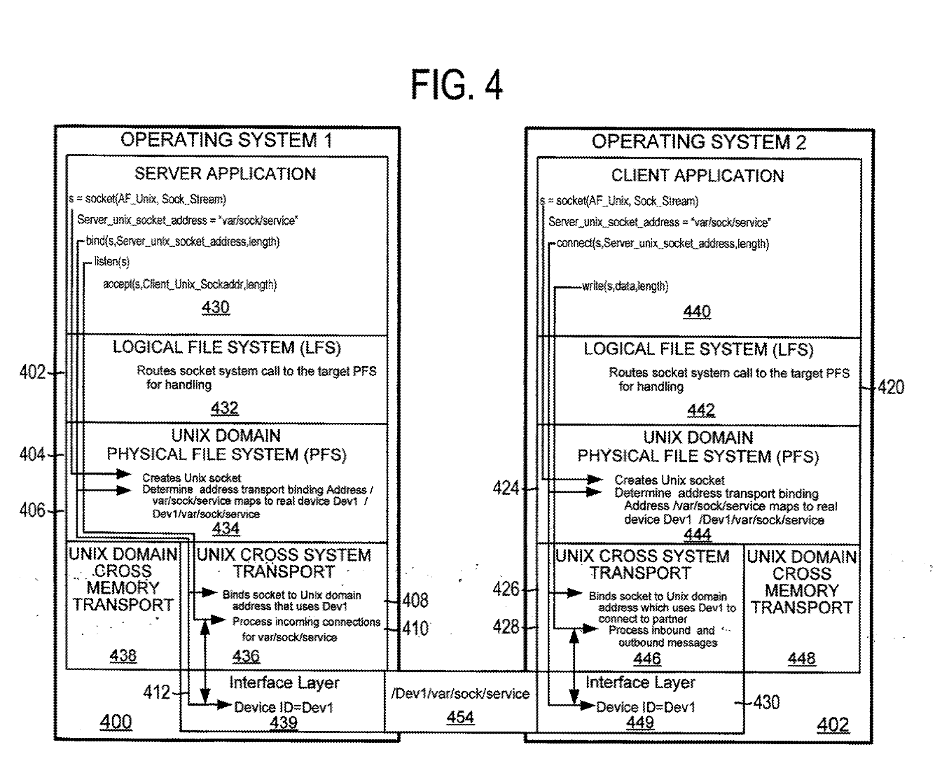

In accordance with one exemplary embodiment of the present invention, for Unix domain sockets are extended for communication over the Internet domain. FIG. 4 represents this concept diagrammatically, in which client application 440 is running on one operating system and server application 430 is running on a completely unique operating system, OS 402 and OS 400. The flow in FIG. 4 shows an identical Unix domain socket applications described in FIG. 2. These systems support cross-system Unix domain sockets and are tightly coupled in that they are connected by a hardware point-to-point type input/output device (steps 412 and 430). The applications still issue system socket calls sockets, bind( ), connect( ) to the service, /var/sock/service, as illustrated in FIG. 3, and may be unaware that they reside on different systems. As discussed elsewhere above, logical file systems (LES) (442 and 432) routes the socket system call to the PFS (steps 402 and 420), as described above, wherein the socket is created (steps 424 and 404) for client application 440 and the server application 430. When the bind( ) and connect( ) occur for the server and the client respectively, on each operating system, the Unix domain PFS will now perform a function on the Unix domain address specified (the file system name) to determine if it represents a cross system binding or a cross memory binding as in prior art. In accordance to one exemplary embodiment of the present invention, PFSs 442 and 432 must be modified with support to make this determination (steps 424 and 406). When a PFS (either client LFS 442 or server LFS 432) determines that this is really a cross-system binding, it will then choose the Unix domain cross system transport instead of the cross-memory transport (steps 426 and 408). This transport will now interface to a real input/output device connected to the other computer system (Steps 412 and 430). Once the bindings have occurred, the transports are now prepared for a connection and the sending and receiving of messages. (Steps 410 and 428).

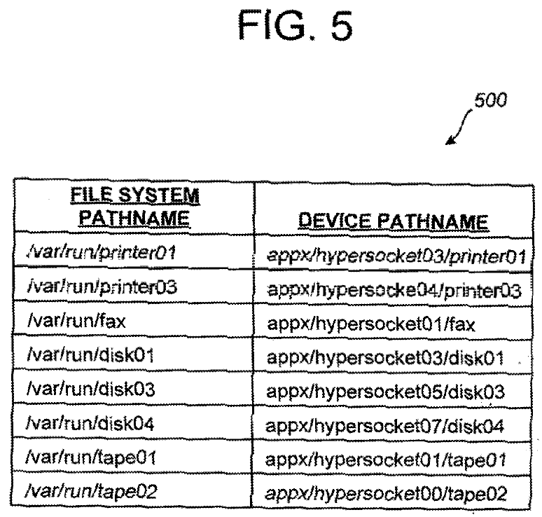

In accordance with still another exemplary embodiment of the present invention, the AF_Unix PES is modified to include file system pathname definitions that are mapped to device pathnames for services that are running on a different operating system image. In so doing, the PFS translates the native Unix file system pathnames in the AF_Unix system calls to a name that represents real I/O device pathnames for applications running on operating system images that are different from that of the application. In contrast with the prior art, the PFS uses the device pathname to create a communication endpoint at the point-to-point I/O device and establish a connection to a partner service in a partition running an operating system image that is different from that of the application by using the point-to-point I/O device. An exemplary table of file system pathname definitions is illustrated in FIG. 5 as table 500 with the corresponding representative device pathname mappings. The PES may not literally translate a file system pathname to a device pathname, but may instead merely recognize that a file system pathname is symbolic of a particular device pathname. In any case, the device pathnames represent a cross system binding for communication. The PFS may continue to handle system calls to processes running on the same operating system image as the application in the usually manner, without translating the Unix file system pathname.

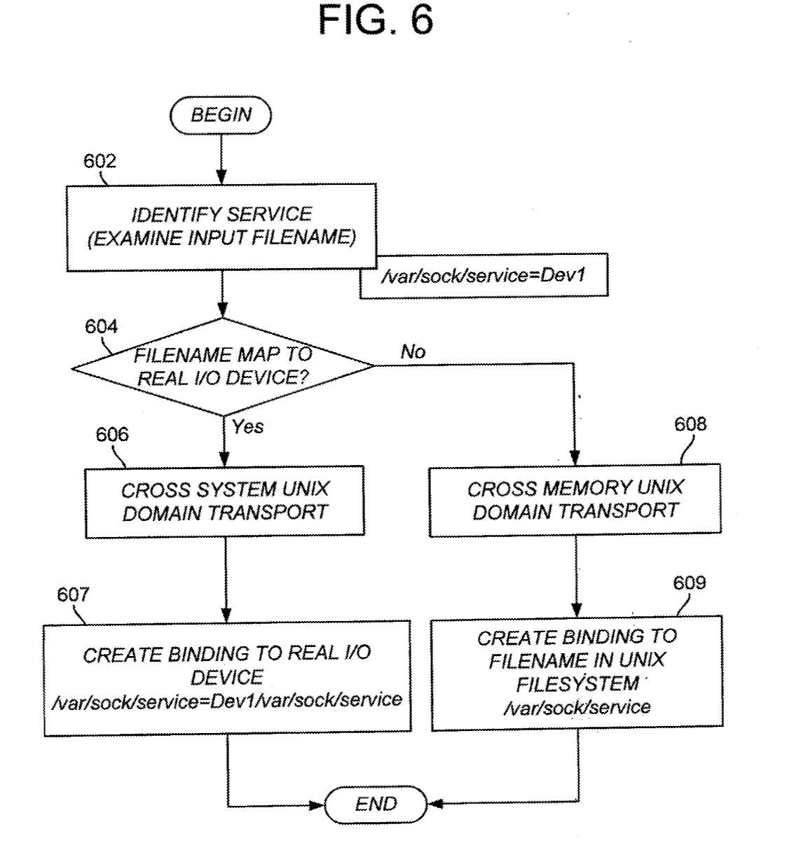

FIG. 6 is a flowchart depicting the corresponding methods for handling system calls on an operating system which supports Unix Domain sockets for both cross system and same system services and determining if the transport used for this communication should be the cross-system or the same-system. The flowchart depicted in FIG. 6 illustrates a method employed by the operating system for handling system calls in accordance with an exemplary embodiment of the present invention. The flowchart illustrates a high-level the application, which may either be a client or a server, that is using Unix domain sockets and begins by invoking the socket system calls. When the application issues the system call to invoke a communication binding, using the bind( ) or connect( ) system calls, the PFS has a decision to make based upon the Unix domain filename passed on these calls. The PFS must determine if this filename represents a real input/output device defined to the system (step. 602) and therefore a cross-system communication or if it represents a cross-memory communication. The PES can make this determination in any one of a variety of way, such as using a device table. Once the PFS makes this determination (step. 604), then it will select the transport in which to create the binding between the application and the transport (steps 606 and 608). These methods illustrate only the high level processes implemented at the application operating system level.

Returning to the top of the flowchart in FIG. 6, the system call is received at the PES which compares the Unix file system pathname to a device pathnames definition (step 602). The comparison may be accomplished through the use of a table of file system pathname definitions, such as that illustrated in FIG. 5 as table 500. The table provides correlations between file path names and device path names for processes running on different operating system images of the same system. If a device pathname definition does not exist for the service, then the system call is handled identically to that described above for Unix domain sockets, that is the LFS uses the system file pathname as the communication binding and selects the appropriate Unix domain same-system transport (e.g., a cross memory transport).

Additionally, if a device definition mapping does exist for the service, that is, for the file system pathname intended to create a communication path to the service, then the communication binding character string in the system call is merely symbolic of a device pathname and is translated into an appropriate device pathname for the application and service (step 606). Recall that the communication between the client-application and server-service will be at the device level and between a pair of point-to-point 110 devices under the respective operating system images channel, for instance. In one example, the file system pathname “/var/run/printer01” may translate to “note7/hypersocket03/printer01.” That device pathname will define a connect path between the application Lotus® Notes® 7 and the service printer using a communication path identified as hypersocket03 (Lotus and Notes are registered trademarks of International Business Machines Corporation in the United States, internationally or both).

With the device pathname, the PFS can select the appropriate Unix domain cross-system transport for the pipe (depicted as transport 438 in the transport layer of FIG. 4) (steps 408 and 426). The transport is built over point-to-point I/O device 439 that bridges the server and client. In the case of the example described above, point-to-point I/O device (steps 412 and 430) is a path or connection channel between point-to-point I/O device 439 and point-to-point I/O device 449 while the entire communication path is represented by the device pathname for the file system pathname 454. As a practical matter, point-to-point I/O device 439 and point-to-point I/O device 449 represent the communication endpoints between particular server 400 and client 402. Thus, the client-application and server-service can communicate using standard Unix domain socket calls.

It should be understood that the interprocess communication need be across operating system images, but may instead be established between processes on the same operating system. While it is expected that the operating system will process the AF_Unix domain sockets consistent with that of the prior art (discussed with reference to FIG. 1), point-to-point I/O devise may be created between partitions with the same operating system image. Furthermore, while the present invention has been described in term of the functionality of the LFS and PFS, these functions are attributable to the operating system and may be delegated to other logical components. Still further, the application may specify the device pathname rather than the operating system.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method for extending Unix domain sockets for communication, comprising:
receiving a Unix domain system call from a process to establish communication with a second process;
recognizing a file system pathname in the system call;
translating the file system pathname to a real I/O device pathname for communication with the second process; and
establishing a connection for the second process using the device pathname.

2. The method recited in claim 1 further comprising:
determining the device pathname for the second process from the system pathname.

3. The method recited in claim 1 further comprising:
finding the device pathname for the second process from a plurality of device pathnames for a plurality of unique services.

4. The method recited in claim 1, wherein the process and second process are running on different operating system images.

5. The method recited in claim 1 wherein the device pathname comprises an identifier for the process and an identifie for the second process and an identifier for a communication channel.

6. The method recited in claim 1, further comprising:
binding to a communication channel.

7. The method recited in claim 6, wherein the communication channel is a real Input/Output (I/O) device between the first process and the second process.

8. The method recited in claim 1 wherein establishing a connection for the second process using the device pathname further comprises:
selecting a cross-system transport for the device pathname; and
invoking a real I/O device between the process and the second process.

9. The method recited in claim 1 further comprising:
receiving a second Unix domain system call from the process to establish communication with a third process;
recognizing a second file system pathname in the second system call; and
establishing a connection for the third process using the second files system pathname.

10. A computer program product for extending Unix domain sockets for communication, said computer program product comprising:
a computer usable medium having computer useable program code embodied therewith, the computer usable program code comprising:
computer usable program code to receive a Unix domain system call from a process to establish communication with a second process;
computer usable program code to recognize a file system pathname in the system call;
computer usable program code to translate the file system pathname to a real I/O device pathname for communication with the second process; and
computer usable program code to establish a connection for the second process using the device pathname.

11. The computer program product recited in claim 10 further comprising:
computer usable program code to determine the device pathname for the second process from the system pathname.

12. The computer program product recited in claim 10 further comprising:
computer usable program code to find the device pathname for the second process from a plurality of device pathnames for a plurality of unique services.

13. The computer program product recited in claim 10, wherein the process and second process are running on different operating system images.

14. The computer program product recited in claim 10, wherein the device pathname comprises an identifier for the process and an identifier for the second process and an identifier for a communication channel.

15. The computer program product recited in claim 10, further comprising;
computer usable program code to bind to a communication channel.

16. The computer program product recited in claim 15, wherein the communication channel is a real Input/Output (I/O) device between the first process and the second process.

17. The computer program product recited in claim 10, wherein the computer usable program code to establish a connection for the second process using the device pathname further comprises:
computer usable program code to select a cross-system transport for the device pathname; and
invoking a real I/O device between the process and the second process.

18. The computer program product recited in claim 10, further comprising:
computer usable program code to receive a second Unix domain system call from the process to establish communication with a third process;
computer usable program code to recognize a second file system pathname in the second system call; and
computer usable program code to establish a connection for the third process using the second files system pathname.

19. A system for extending Unix domain sockets for communication comprising:
a first operating system image with a first application running on the first operating system image, Unix file system, a first Unix cross memory transport for invoking the Unix file system, a first point-to-point input/output device, a first Unix domain cross system transport for invoking the first point-to-point input/output device, and a first Unix domain physical file system with logic for receiving system calls from the first application and selecting one of the first Unix cross memory transport and the first Unix domain cross system transport for establishing a connection; and
a second operating system image with a second application running on the second operating system images Unix file system, a second Unix cross memory transport for invoking the Unix file system, a second point-to-point input/output device a second Unix domain cross system transport for invoking the second point-to-point input/output device, and a second Unix domain physical file system with logic for receiving system calls from the second application and selecting one of the second Unix cross memory transport and the second Unix domain cross system transport for establishing a connection.

20. A system recited in claim 19 above, wherein the first and second Unix domain physical file systems further comprise logic for recognizing a file system pathname in a system call and for translating the recognized file system pathname to a real I/O device pathname.
